(19) United States
(12) Patent Application Publication
(10) Pub. No.: US 2020/0325775 A1
(43) Pub. Date: Oct. 15, 2020

(54) SYSTEM FOR ACQUIRING MOVEMENT INFORMATION OF HIGH-LEVEL ROCK STRATUM IN COAL MINE STOPE, AND ACQUISITION AND ANALYSIS METHOD

(71) Applicant: China University of Mining and Technology, Beijing, Beijing (CN)

(72) Inventors: Jiachen Wang, Beijing (CN); Shengli Yang, Beijing (CN); Hao Yue, Beijing (CN); Zhaohui Wang, Beijing (CN); Lianghui Li, Beijing (CN)

(21) Appl. No.: 16/666,499

(22) Filed: Oct. 29, 2019

(30) Foreign Application Priority Data
Apr. 9, 2019 (CN) 201910279926.1

(51) Int. Cl. E21C 41/18; E21B 47/026; G01V 3/38; H04W 4/02

(52) U.S. Cl. CPC E21C 41/18; H04W 4/027; G01V 3/38; E21B 47/026

(57) ABSTRACT

Disclosed are systems and methods for acquiring movement information of a high-level rock stratum (HLRS) in a coal mine stope. The system includes information acquisition, information acquisition transfer, information storage and rock stratum position-state information analysis modules that are sequentially connected wireles sly; the information acquisition module is disposed in a drill hole of the HLRS; the information acquisition transfer module is disposed below the information acquisition module; the information storage module is disposed in a working area of the stope; the rock stratum position-state information analysis module is disposed in a haulage roadway of the stope. Movement information, acquired by the information acquisition module, of the HLRS is transferred to the storage module via the information acquisition transfer module in real time, and then is transmitted to the rock stratum position-state information analysis module for real-time processing, thereby obtaining the movement information of the HLRS and predicting a movement trend.

This application claims priority to Chinese application number 201910279926.1, filed Apr. 9 2018, with a title of SYSTEM FOR ACQUIRING MOVEMENT INFORMATION OF HIGH-LEVEL ROCK STRATUM IN COAL MINE STOPE, AND ACQUISITION AND ANALYSIS METHOD. The above-mentioned patent application is incorporated herein by reference in its entirety.

### TECHNICAL FIELD

The present invention relates to the technical field of coal mine engineering, and in particular to a system for acquiring movement information of a high-level rock stratum in a coal mine stope, and acquisition and analysis methods.

### BACKGROUND

A roof accident in a coal mine has a very large hazard, and takes up a large portion in accidents of the coal mine. The roof accident of the coal mine is mainly determined by a movement of a high-level rock stratum in a coal bed. The movement of the high-level rock stratum in the coal bed may cause an accident, such as rock burst and roof weighting, of the coal mine. The movement of the high-level rock stratum has a crucial impact on the coal mine, so it is very important to master position-state information of the high-level rock stratum. If the movement of the high-level rock stratum may be observed in real time, a movement trend of a roof can be predicted in advance; and according to the mastered movement trend of the roof, a corresponding measure is taken to reduce or prevent some disasters. Meanwhile, according to movement information of the high-level rock stratum, a support pressure near to a working surface may be predicted to provide a basis for parameter selection of the working surface and arrangement of a protective coal pillar, which has a very important significance to safe exploitation of the coal mine. Therefore, it is crucial to observe the movement of the high-level rock stratum in real time and predict the movement trend of the high-level rock stratum.

### SUMMARY

An objective of the present invention is to provide a system for acquiring movement position-state information of a high-level rock stratum in a coal mine stope by observing a movement of the high-level rock stratum in real time and predicting a movement trend of the high-level rock stratum, and acquisition and analysis methods.

To achieve the above purpose, the present invention provides the following technical solutions.

A system for acquiring movement information of a high-level rock stratum in a coal mine stope includes an information acquisition module, an information acquisition transfer module, an information storage module and a rock stratum position-state information analysis module that are connected wireles sly in sequence, where

a drill hole is formed in the high-level rock stratum; the drill hole extends downward to a roof; and the roof is a top surface in a working area of the coal mine stope;

the information acquisition module is disposed at a position in the drill hole and corresponding to the high-level rock stratum, and is configured to acquire the movement information of the high-level rock stratum, and transmit the movement information to the information acquisition transfer module in real time;

the information acquisition transfer module is disposed below the information acquisition module in the drill hole, and is configured to transmit the received movement information to the information storage module in real time;

the information storage module is disposed in the working area of the coal mine stope, and is configured to store the received movement information, and transmit the received movement information to the rock stratum position-state information analysis module in real time; and

the rock stratum position-state information analysis module is disposed in a haulage roadway of the coal mine stope, and is configured to process and analyze the received movement information in real time to obtain position-state information and a movement trend of the high-level rock stratum.

Optionally, the information acquisition module is a gyroscope; and

the movement information is a rotational angular velocity when the gyroscope deflects and inclines.

Optionally, the information acquisition transfer module includes a plurality of information acquisition transfer base stations;

the plurality of information acquisition transfer base stations are disposed below the information acquisition module sequentially along the drill hole; and

each information transfer base station is wirelessly connected to an adjacent information transfer base station, and each information transfer base station is configured to transfer the movement information in real time till the movement information is transferred to the information storage module.

Optionally, the drill hole is formed rightly above the roof within a set range toward a working surface coal wall, and an included angle between an upward extending direction of the drill hole and an advancing direction of the working surface coal wall is an obtuse angle.

Optionally, the information storage module is disposed on a front column of a hydraulic bracket in the working area of the coal mine stope, and moves forward along with the hydraulic bracket.

A method for acquiring movement information of a high-level rock stratum in a coal mine stope is further provided, applied to the system for acquiring the movement information of the high-level rock stratum in the coal mine stope according, and including:

whenever a working surface coal wall is advanced for a set distance, forming a drill hole on a roof and toward the high-level rock stratum;

disposing an information acquisition module and an information acquisition transfer module in the drill hole to acquire and transfer movement information that the drill hole corresponds to the high-level rock stratum to a storage module; and

transmitting, by the storage module, the movement information that the drill hole corresponds to the high-level rock stratum to a rock stratum position-state information analysis module for processing.

Optionally, the movement information, acquired by the information acquisition module, of the high-level rock stratum is a rotational angular velocity when a gyroscope deflects and inclines with the movement of the high-level rock stratum.

Optionally, a process that the information acquisition transfer module transfers the movement information to the information storage module in real time is as follows: transferring, by each adjacent information acquisition transfer base station in the same drill hole, the received movement information sequentially from the top down till the received movement information is transmitted to the information storage module.

A method for analyzing movement information of a high-level rock stratum in a coal mine stope is further provided, applied to the system for acquiring the movement information of the high-level rock stratum in the coal mine stope, and including:

sequentially obtaining a rotational angular velocity of a gyroscope at T₀, T₁, . . . , Tₙ, moments according to a time chronological sequence, N≥0;

recording an actual position where the gyroscope is located at the T₀ moment as an initial position;

according to a rotational angular velocity of the gyroscope at a Tᵢ moment and a Tᵢ₋₁ moment, calculating to obtain a relative position of the gyroscope at the Tᵢ moment relative to the Tᵢ₋₁ moment, i=1, 2, . . . , n;

according to an actual position of the gyroscope at the Tᵢ₋₁ moment and the calculated relative position of the gyroscope at the Tᵢ, moment relative to the Tᵢ₋₁ moment, obtaining an actual position where the gyroscope is located at the Tᵢ moment;

determining whether i is equal to the n to obtain a determining result;

if the determining result is no, adding 1 to a value of the i, and returning to the step “according to a rotational angular velocity of the gyroscope at a Tᵢ moment and a Tᵢ₋₁ moment, calculating to obtain a relative position of the gyroscope at the Tᵢ moment relative to the Tᵢ₋₁ moment”; and

if the determining result is yes, sequentially connecting, according to the time chronological sequence, the actual position where the gyroscope is located at the T₀, T₁, . . . , Tₙ moments to obtain a movement track of the gyroscope.

According to specific embodiments provided in the present invention, the present invention discloses the following technical effects:

By disposing an information acquisition module in a high-level rock stratum, movement information of the high-level rock stratum is acquired in real time; and the movement information is transmitted to a rock stratum position-state information analysis module via an information acquisition transfer module and an information storage module for real-time analysis, thereby obtaining the movement information of the high-level rock stratum in an exploitation process of a coal mine and predicting a movement trend of the high-level rock stratum.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a system for acquiring movement information of a high-level rock stratum in a coal mine stope provided by an embodiment of the present invention.

FIG. 2 is a schematic diagram of a process for transmitting acquired data of movement information of a high-level rock stratum in a coal mine stope provided by an embodiment of the present invention.

FIG. 3 is a flowchart for analyzing movement information of a high-level rock stratum in a coal mine stope provided by an embodiment of the present invention.

In the figure:

1-information acquisition module; 2-information acquisition transfer module; 3-drill hole; 4-roof; 5-information storage module; 6-coal wall; 7-hydraulic bracket; and 8-high-level rock stratum.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide a system for acquiring movement position-state information of a high-level rock stratum in a coal mine stope by observing a movement of the high-level rock stratum in real time and predicting a movement trend of the high-level rock stratum, and acquisition and analysis methods.

To make the foregoing objective, features, and advantages of the present invention clearer and more comprehensible, the present invention is further described in detail below with reference to the accompanying drawings and specific embodiments.

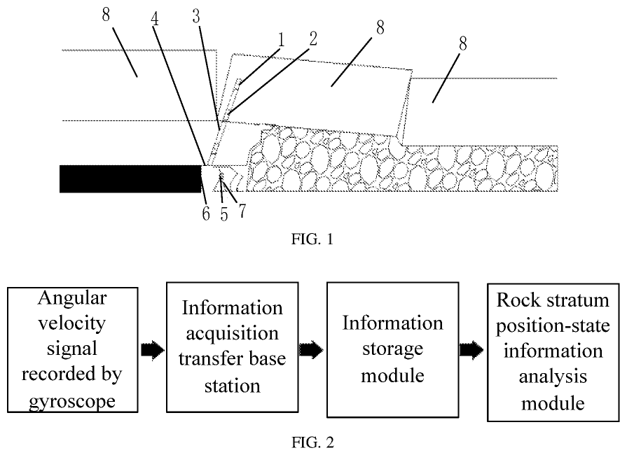

FIG. 1 is a schematic diagram of a system for acquiring movement information of a high-level rock stratum in a coal mine stope provided by an embodiment of the present invention. As shown in FIG. 1, the system for acquiring the movement information of the high-level rock stratum in the coal mine stope includes an information acquisition module 1, an information acquisition transfer module 2, an information storage module 5 and a rock stratum position-state information analysis module that are connected wirelessly in sequence;

a drill hole 3 is formed in the high-level rock stratum 8; the drill hole 3 extends downward to a roof 4; and the roof 4 is a top surface in a working area of the coal mine stope;

the information acquisition module 1 is disposed at a position in the drill hole 3 and corresponding to the high-level rock stratum 8, and is configured to acquire the movement information of the high-level rock stratum 8, and transmit the movement information to the information acquisition transfer module 2 in real time;

the information acquisition transfer module 2 is disposed below the information acquisition module 1 in the drill hole 3, and is configured to transmit the received movement information to the information storage module 5 in real time;

the information storage module 5 is disposed in the working area of the coal mine stope, and is configured to store the received movement information, and transmit the received movement information to the rock stratum position-state information analysis module in real time; and

the rock stratum position-state information analysis module is disposed in a haulage roadway of the coal mine stope, and is configured to process and analyze the received movement information in real time to obtain position-state information and a movement trend of the high-level rock stratum 8.

The information acquisition module 1 is a gyroscope; and

the movement information is a rotational angular velocity when the gyroscope deflects and inclines.

The information acquisition transfer module 2 includes a plurality of information acquisition transfer base stations;

the plurality of information acquisition transfer base stations are disposed below the information acquisition module 1 sequentially along the drill hole 3; and

each information transfer base station is wirelessly connected to an adjacent information transfer base station, and each information transfer base station is configured to transfer the movement information in real time till the movement information is transferred to the information storage module 5.

The drill hole 3 is formed rightly above the roof 4 within a set range toward a working surface coal wall 6, and an included angle between an upward extending direction of the drill hole 3 and an advancing direction of the working surface coal wall 6 is an obtuse angle.

The information storage module 5 is disposed on a front column of a hydraulic bracket 7 in the working area of the coal mine stope, and moves forward along with the hydraulic bracket 7.

By disposing an information acquisition module 1 in a high-level rock stratum 8, movement information of the high-level rock stratum 8 is acquired in real time; and the movement information is transmitted to a rock stratum position-state information analysis module via an information acquisition transfer module 2 and an information storage module 5 for real-time analysis, thereby obtaining the movement information of the high-level rock stratum 8 in an exploitation process of a coal mine and predicting a movement trend of the high-level rock stratum 8.

A gyroscope is fixed in the high-level rock stratum 8 of a coal bed via a drill hole 3; when the high-level rock stratum 8 moves, an angular velocity of the gyroscope makes a change; by recording a rotational angular velocity when the gyroscope deflects and inclines, transferring the rotational angular velocity via an information acquisition transfer module 2 to transmit to an information storage base station, and at last processing the rotational angular velocity by a rock stratum position-state information analysis module, movement information of the high-level rock stratum 8 in an exploitation process of a coal mine is obtained and a movement trend of the high-level rock stratum 8 is predicted; and thus, a corresponding measure is taken to achieve an objective of preventing or reducing an underground disaster of the coal mine.

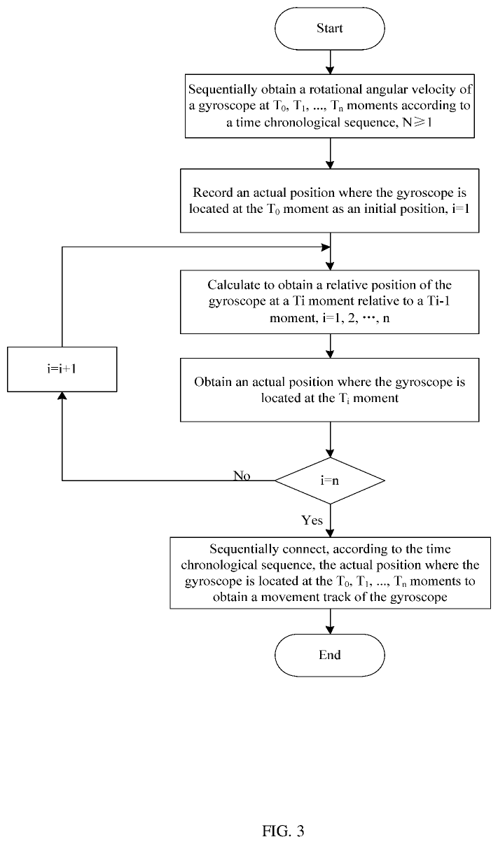

FIG. 2 is a schematic diagram of a process for transmitting acquired data of movement information of a high-level rock stratum in a coal mine stope provided by an embodiment of the present invention. As shown in FIG. 2, a method for acquiring movement information of a high-level rock stratum in a coal mine stope includes the following steps.

Whenever a working surface coal wall 6 is advanced for a set distance, form a drill hole 3 on a roof 4 and toward the high-level rock stratum 8.

Dispose an information acquisition module 1 and an information acquisition transfer module 2 in the drill hole 3 to acquire and transfer movement information that the drill hole 3 corresponds to the high-level rock stratum 8 to a storage module.

Transmit, by the storage module, the movement information that the drill hole 3 corresponds to the high-level rock stratum 8 to a rock stratum position-state information analysis module for processing.

The movement information, acquired by the information acquisition module 1, of the high-level rock stratum 8 is a rotational angular velocity when a gyroscope deflects and inclines with the movement of the high-level rock stratum 8.

A process that the information acquisition transfer module 2 transfers the movement information to the information storage module 5 in real time is as follows: transfer, by each adjacent information acquisition transfer base station in the same drill hole 3, the received movement information sequentially from the top down till the received movement information is transmitted to the information storage module 5.

Along with the advancement of a working surface, an information storage module 5 is pushed ahead with a hydraulic bracket 7, and an information acquisition module 1 and an information acquisition transfer module 2 disposed in a drill hole 3 are collapsed with a rock stratum and are not recycled. Whenever the working surface is advanced for a certain distance, a drill hole 3 is re-formed on a roof 4, and the information acquisition module 1 and the information acquisition transfer module 2 are re-disposed in the drill hole 3. The information acquisition module 1 and the information acquisition transfer module 2 that are disposed newly and the information acquisition module 1 and the information acquisition transfer module 2 that have been already disposed in the drill hole 3 previously all keep acquisition and transfer functions for movement data information. All information acquisition transfer modules 2 are wirelessly connected to the information storage module 5. All acquired movement data are transmitted to the information storage module 5 to be processed and used by a rock stratum position-state information analysis module, thereby obtaining more comprehensive movement information of the high-level rock stratum 8 and predicting a more accurate movement trend.

With the utilization of a gyroscope, an information acquisition transfer base station, the information storage module 5 and the rock stratum position-state information analysis module, underground invisible position-state information of the high-level rock stratum 8 may be converted into visible real-time position-state information, which has a great significance to reduce underground roof 4 weighting and rock burst accidents of a coal mine; and meanwhile, according to the position-state information of the high-level rock stratum 8, a parameter of the working surface, a width of a protective coal pillar and the like may be designed.

FIG. 3 is a flowchart for analyzing movement information of a high-level rock stratum in a coal mine stope provided by an embodiment of the present invention. As shown in FIG. 3, a method for analyzing movement information of a high-level rock stratum in a coal mine stope includes the following steps.

Sequentially obtain a rotational angular velocity of a gyroscope at T₀, T₁, . . . , Tₙ moments according to a time chronological sequence, N≥0.

Record an actual position where the gyroscope is located at the T₀ moment as an initial position.

According to a rotational angular velocity of the gyroscope at a Tᵢ moment and a Tᵢ₋₁ moment, calculate to obtain a relative position of the gyroscope at the Tᵢ moment relative to the Tᵢ₋₁ moment, i=1, 2, . . . , n.

According to an actual position of the gyroscope at the Tᵢ₋₁ moment and the calculated relative position of the gyroscope at the Tᵢ moment relative to the Tᵢ₋₁ moment, obtain an actual position where the gyroscope is located at the Tᵢ moment.

Determine whether i is equal to the n to obtain a determining result.

If the determining result is no, add 1 to a value of the i, and return to the step “according to a rotational angular velocity of the gyroscope at a Tᵢ moment and a Tᵢ₋₁ moment, calculate to obtain a relative position of the gyroscope at the Tᵢ moment relative to the Tᵢ₋₁ moment”.

If the determining result is yes, sequentially connect, according to the time chronological sequence, the actual position where the gyroscope is located at the T₀, T₁, . . . , Tₙ moments to obtain a movement track of the gyroscope.

A gyroscope is fixed in a high-level rock stratum 8 of a coal bed via a drill hole 3. When the high-level rock stratum 8 moves, an angular velocity of the gyroscope makes a change, so initial position-state information of the gyroscope is recorded first. When the high-level rock stratum 8 moves, the gyroscope inclines, and the angular velocity is changed simultaneously. An angular velocity signal is transmitted to an information storage module 5 via an information acquisition transfer base station, and at last an angular velocity signal difference is processed by a rock stratum position-state information analysis module. According to the change of the angular velocity, a relative position relative to a previous position may be obtained via a series of calculations; a relative value relative to previous location may be obtained in each calculation; and at last, a movement track of the gyroscope may be obtained, i.e., position-state information of the high-level rock stratum 8 is obtained. Therefore, a movement trend of an overlying rock stratum of a coal mine may be effectively predicted to provide an effective basis for prevention of a disaster of the coal mine.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

1. A system for acquiring movement information of a high-level rock stratum in a coal mine stope, comprising an information acquisition module, an information acquisition transfer module, an information storage module and a rock stratum position-state information analysis module that are connected wirelessly in sequence, wherein
a drill hole is formed in the high-level rock stratum; the drill hole extends downward to a roof; and the roof is a top surface in a working area of the coal mine stope;
the information acquisition module is disposed at a position in the drill hole and corresponding to the high-level rock stratum, and is configured to acquire the movement information of the high-level rock stratum, and transmit the movement information to the information acquisition transfer module in real time;
the information acquisition transfer module is disposed below the information acquisition module in the drill hole, and is configured to transmit the received movement information to the information storage module in real time;
the information storage module is disposed in the working area of the coal mine stope, and is configured to store the received movement information, and transmit the received movement information to the rock stratum position-state information analysis module in real time; and
the rock stratum position-state information analysis module is disposed in a haulage roadway of the coal mine stope, and is configured to process and analyze the received movement information in real time to obtain position-state information and a movement trend of the high-level rock stratum.

2. The system for acquiring the movement information of the high-level rock stratum in the coal mine stope according to claim 1, wherein
the information acquisition module is a gyroscope; and
the movement information is a rotational angular velocity when the gyroscope deflects and inclines.

3. The system for acquiring the movement information of the high-level rock stratum in the coal mine stope according to claim 1, wherein
the information acquisition transfer module comprises a plurality of information acquisition transfer base stations;
the plurality of information acquisition transfer base stations are disposed below the information acquisition module sequentially along the drill hole; and
each information transfer base station is wireles sly connected to an adjacent information transfer base station, and each information transfer base station is configured to transfer the movement information in real time till the movement information is transferred to the information storage module.

4. The system for acquiring the movement information of the high-level rock stratum in the coal mine stope according to claim 1, wherein
the drill hole is formed rightly above the roof within a set range toward a working surface coal wall, and an included angle between an upward extending direction of the drill hole and an advancing direction of the working surface coal wall is an obtuse angle.

5. The system for acquiring the movement information of the high-level rock stratum in the coal mine stope according to claim 1, wherein
the information storage module is disposed on a front column of a hydraulic bracket in the working area of the coal mine stope, and moves forward along with the hydraulic bracket.

6. A method for acquiring movement information of a high-level rock stratum in a coal mine stope, applied to the system for acquiring the movement information of the high-level rock stratum in the coal mine stope according to claim 1, and comprising:
whenever a working surface coal wall is advanced for a set distance, forming a drill hole on a roof and toward the high-level rock stratum;
disposing an information acquisition module and an information acquisition transfer module in the drill hole to acquire and transfer movement information that the drill hole corresponds to the high-level rock stratum to a storage module; and
transmitting, by the storage module, the movement information that the drill hole corresponds to the high-level rock stratum to a rock stratum position-state information analysis module for processing.

7. The method for acquiring the movement information of the high-level rock stratum in the coal mine stope according to claim 6, wherein
the movement information, acquired by the information acquisition module, of the high-level rock stratum is a rotational angular velocity when a gyroscope deflects and inclines with the movement of the high-level rock stratum.

8. The method for acquiring the movement information of the high-level rock stratum in the coal mine stope according to claim 6, wherein
a process that the information acquisition transfer module transfers the movement information to the information storage module in real time is as follows: transferring, by each adjacent information acquisition transfer base station in the same drill hole, the received movement information sequentially from the top down till the received movement information is transmitted to the information storage module.

9. A method for analyzing movement information of a high-level rock stratum in a coal mine stope, applied to the system for acquiring the movement information of the high-level rock stratum in the coal mine stope according to claim 2, and comprising:
sequentially obtaining a rotational angular velocity of a gyroscope at T₀, T₁, . . . , Tₙ moments according to a time chronological sequence, N≥0;
recording an actual position where the gyroscope is located at the T₀ moment as an initial position;
according to a rotational angular velocity of the gyroscope at a Tᵢ moment and a Tᵢ₋₁ moment, calculating to obtain a relative position of the gyroscope at the Tᵢ moment relative to the Tᵢ₋₁ moment, i=1, 2, . . . , n;
according to an actual position of the gyroscope at the Tᵢ₋₁ moment and the calculated relative position of the gyroscope at the Tᵢ moment relative to the Tᵢ₋₁ moment, obtaining an actual position where the gyroscope is located at the Tᵢ moment;
determining whether i is equal to the n to obtain a determining result;
if the determining result is no, adding 1 to a value of the i, and returning to the step “according to a rotational angular velocity of the gyroscope at a Tᵢ moment and a Tᵢ₋₁ moment, calculating to obtain a relative position of the gyroscope at the Tᵢ moment relative to the Tᵢ₋₁ moment”; and
if the determining result is yes, sequentially connecting, according to the time chronological sequence, the actual position where the gyroscope is located at the T₀, T₁, . . . , Tₙ moments to obtain a movement track of the gyroscope.

10. A method for acquiring movement information of a high-level rock stratum in a coal mine stope, applied to the system for acquiring the movement information of the high-level rock stratum in the coal mine stope according to claim 2, and comprising:
whenever a working surface coal wall is advanced for a set distance, forming a drill hole on a roof and toward the high-level rock stratum;
disposing an information acquisition module and an information acquisition transfer module in the drill hole to acquire and transfer movement information that the drill hole corresponds to the high-level rock stratum to a storage module; and
transmitting, by the storage module, the movement information that the drill hole corresponds to the high-level rock stratum to a rock stratum position-state information analysis module for processing.

11. A method for acquiring movement information of a high-level rock stratum in a coal mine stope, applied to the system for acquiring the movement information of the high-level rock stratum in the coal mine stope according to claim 3, and comprising:
whenever a working surface coal wall is advanced for a set distance, forming a drill hole on a roof and toward the high-level rock stratum;
disposing an information acquisition module and an information acquisition transfer module in the drill hole to acquire and transfer movement information that the drill hole corresponds to the high-level rock stratum to a storage module; and
transmitting, by the storage module, the movement information that the drill hole corresponds to the high-level rock stratum to a rock stratum position-state information analysis module for processing.

12. A method for acquiring movement information of a high-level rock stratum in a coal mine stope, applied to the system for acquiring the movement information of the high-level rock stratum in the coal mine stope according to claim 4, and comprising:
whenever a working surface coal wall is advanced for a set distance, forming a drill hole on a roof and toward the high-level rock stratum;
disposing an information acquisition module and an information acquisition transfer module in the drill hole to acquire and transfer movement information that the drill hole corresponds to the high-level rock stratum to a storage module; and
transmitting, by the storage module, the movement information that the drill hole corresponds to the high-level rock stratum to a rock stratum position-state information analysis module for processing.

13. A method for acquiring movement information of a high-level rock stratum in a coal mine stope, applied to the system for acquiring the movement information of the high-level rock stratum in the coal mine stope according to claim 5, and comprising:
whenever a working surface coal wall is advanced for a set distance, forming a drill hole on a roof and toward the high-level rock stratum;
disposing an information acquisition module and an information acquisition transfer module in the drill hole to acquire and transfer movement information that the drill hole corresponds to the high-level rock stratum to a storage module; and
transmitting, by the storage module, the movement information that the drill hole corresponds to the high-level rock stratum to a rock stratum position-state information analysis module for processing.

14. The method for acquiring the movement information of the high-level rock stratum in the coal mine stope according to claim 10, wherein
the movement information, acquired by the information acquisition module, of the high-level rock stratum is a rotational angular velocity when a gyroscope deflects and inclines with the movement of the high-level rock stratum.

15. The method for acquiring the movement information of the high-level rock stratum in the coal mine stope according to claim 11, wherein
the movement information, acquired by the information acquisition module, of the high-level rock stratum is a rotational angular velocity when a gyroscope deflects and inclines with the movement of the high-level rock stratum.

16. The method for acquiring the movement information of the high-level rock stratum in the coal mine stope according to claim 12, wherein
the movement information, acquired by the information acquisition module, of the high-level rock stratum is a rotational angular velocity when a gyroscope deflects and inclines with the movement of the high-level rock stratum.

17. The method for acquiring the movement information of the high-level rock stratum in the coal mine stope according to claim 13, wherein
the movement information, acquired by the information acquisition module, of the high-level rock stratum is a rotational angular velocity when a gyroscope deflects and inclines with the movement of the high-level rock stratum.

18. The method for acquiring the movement information of the high-level rock stratum in the coal mine stope according to claim 10, wherein
a process that the information acquisition transfer module transfers the movement information to the information storage module in real time is as follows: transferring, by each adjacent information acquisition transfer base station in the same drill hole, the received movement information sequentially from the top down till the received movement information is transmitted to the information storage module.

19. The method for acquiring the movement information of the high-level rock stratum in the coal mine stope according to claim 11, wherein
a process that the information acquisition transfer module transfers the movement information to the information storage module in real time is as follows: transferring, by each adjacent information acquisition transfer base station in the same drill hole, the received movement information sequentially from the top down till the received movement information is transmitted to the information storage module.

20. The method for acquiring the movement information of the high-level rock stratum in the coal mine stope according to claim 12, wherein
a process that the information acquisition transfer module transfers the movement information to the information storage module in real time is as follows: transferring, by each adjacent information acquisition transfer base station in the same drill hole, the received movement information sequentially from the top down till the received movement information is transmitted to the information storage module.
